(19) United States
(12) Patent Application Publication
(10) Pub. No.: US 2021/0392941 A1
(43) Pub. Date: Dec. 23, 2021

(54) FILLED CLUSTER PRODUCTS AND SYSTEMS AND METHODS FOR CREATING THE SAME

(71) Applicant: The Hershey Company, Hershey, PA (US)

(72) Inventors: Yvette Pascua Cubides, Palmyra, PA (US); Ana Cristina Duque, Annville, PA (US)

(21) Appl. No.: 17/312,456

(22) PCT Filed: Feb. 4, 2020
(86) PCT No.: PCT/US2020/016608

§ 371 Date: Jun. 10, 2021

Related U.S. Application Data
(60) Provisional application No. 62/800,873, filed on Feb. 4, 2019.

(51) Int. Cl. A23P 30/25; A23L 25/00; A23L 7/126; A23L 7/161; A23L 29/30; A23L 29/20; A23L 29/00

(52) U.S. Cl. CPC A23P 30/25; A23L 25/30; A23L 7/126; A23V 2002/00; A23L 29/30; A23L 29/20; A23L 29/035; A23L 7/161

(57) ABSTRACT

Filled cluster products comprising an inner material and an outer shell, and methods of manufacturing the same, are disclosed. Outer shells comprising delicate exclusions are susceptible to moisture and force and present a challenge in manufacturing filled cluster products. Typical filled cluster products with delicate extrusions have an outer shell with a high binder to exclusion ratio and significant sugar content. Disclosed herein are methods and formulations for the manufacture of filled cluster products having low binder to exclusion ratio and a low sugar content.

### BACKGROUND

The technical field relates generally to filled cluster products and systems and methods for creating the same.

### SUMMARY

Embodiments of the present disclosure provide filled cluster products and systems and methods for creating the same. Filled cluster products comprise a center made of a center material and an outer shell that comprises a binder and exclusions. The outer to shell may also be referred to as an outer layer, an exterior layer, and the like.

Filled snacks are typically manufactured by a panning or co-extrusion process. In the co-extrusion process, the outer layer exclusions are easily damaged by machine forces. To address this problem, a high ratio of binder to exclusions is typically used to facilitate flow of the outer material stream through the co-extruder nozzle die. This high binder to exclusion ratio results in a filled cluster product having an exterior layer composed of more binder than exclusions.

Alternatively, the exterior particulates may be wetted to make them more cohesive and flexible enough to pass though the extruder die with reduced damage. However, the increased moisture used in this production path destroys the structural integrity and texture of delicate puffed or popped exclusions.

Exclusions that are popped, puffed, or the like, are damaged by threshold amounts of pressure or water and are referred to herein as delicate exclusions. Other examples of exclusions include nuts, oats, dried fruits, pretzels, and the like.

Therefore, there is an unmet need for a filled cluster product that has an exterior layer with a greater amount of exclusions relative to the binder material, and methods for manufacturing the filled cluster product.

### DESCRIPTION OF THE FIGURES

FIG. 1 is a cross-sectional view of a filled cluster product, according to a first exemplary embodiment.

FIG. 2 is a schematic illustration of a system for forming the filled cluster product of FIG. 1, according to a first exemplary embodiment.

FIG. 3 is a flow chart of a process for forming the filled cluster product of FIG. 1, according to a first exemplary embodiment.

FIG. 4 is a cross-sectional view of a filled cluster product, according to a second exemplary embodiment.

FIG. 5 is a schematic illustration of a system for forming the filled cluster product of FIG. 4, according to a second exemplary embodiment.

FIG. 6 is a flow chart of a process for forming the filled cluster product of FIG. 4, according to a second exemplary embodiment.

### DETAILED DESCRIPTION

The disclosed embodiments are merely exemplary of various and alternative forms. As used herein, the word “exemplary” is used expansively to refer to embodiments that serve as illustrations, specimens, models, or patterns. The figures are not necessarily to scale and some features may be exaggerated or minimized to show details of particular to components. In other instances, well-known components, systems, materials, or methods that are known to those having ordinary skill in the art have not been described in detail in order to avoid obscuring the present disclosure. Therefore, specific structural and functional details disclosed herein are not to be interpreted as limiting, but merely as a basis for the claims and as a representative basis for teaching one skilled in the art.

Filled cluster products and methods for manufacturing same are described below in further detail with respect to exemplary embodiments.

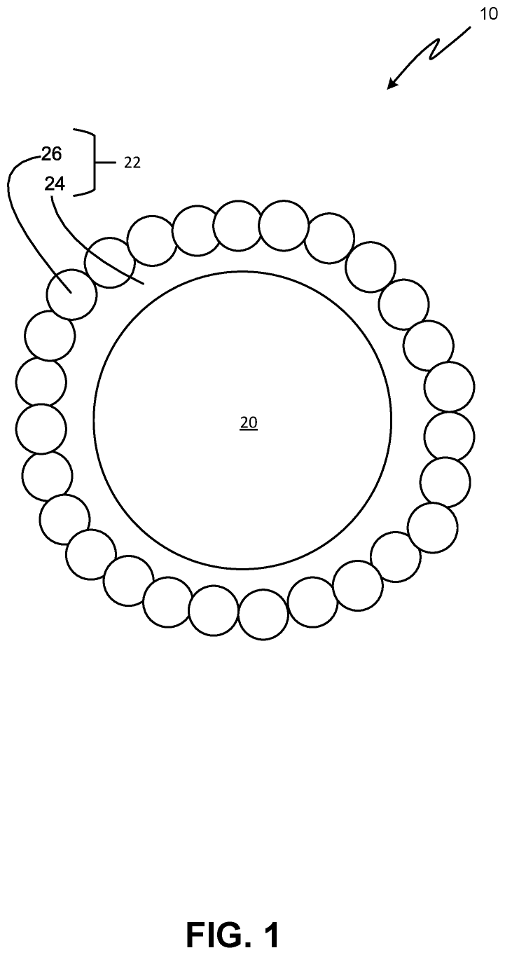

Referring to FIG. 1, a cross-sectional view of the first exemplary embodiment of a filled cluster product 10 includes a center 20 and an outer shell 22. The outer shell 22 includes a binding layer 24 and an exclusion layer 26. The binding layer 24 covers the center 20 and the exclusion layer 26 covers the binding layer 24. FIG. 1 is a cross-sectional view to show the interior structure of the cluster. In an undissected view of the filled cluster product 10 (not shown) the filled cluster product 10 as a sphere, or other solid geometric shape, with only the exclusion layer 26 substantially exposed. The outer shell 22 encloses the center 20.

The center may alternatively be referred to herein as an interior, a core, and the like. The binder may alternatively be referred to herein as a binding, a binding layer, a coating, an enrobing layer, and the like. The exclusions may be referred to as inclusions, exclusions, particulates, an exclusion layer, and the like.

The Center

The center 20 is made of a center material. The center material may be a fat-based material such as a nut butter, seed butter, compound, chocolate, and the like. As used herein the terms “compound” refers to a fat-based substance that uses a fat other than cocoa butter. Alternatively, the center material may be a water-based material such as caramel, high protein caramel, nougat, pectin gel or gummy, starch gel or gummy with sufficiently low water activity that is coated with a protective fat-based barrier that is crystalline at room temperature. As used herein, “water activity” is intended to have its standard definition in the field of food science, namely, the partial vapor pressure of water in a substance divided by the standard state partial vapor pressure of water. A “sufficiently low” water activity in this situation would be a water activity of the center material that does not compromise the structure or function of the protective, fat-based, crystalline barrier. The center material may comprise a combination of fat-based and water-based ingredients. A preferred center material comprises nut butter. The center 20 is made of a center material. The center material may be a fat-based material such as a nut butter, seed butter, compound, chocolate, and the like. As used herein the terms “compound” refers to a fat-based coating that uses a fat other than cocoa butter. Alternatively, the center material may be a water-based material such as caramel, high protein caramel, nougat, pectin gel or to gummy, starch gel or gummy with sufficiently low water activity that is coated with a protective fat-based barrier that is crystalline at room temperature. As used herein, “water activity” is intended to have its standard definition in the field of food science, namely, the partial vapor pressure of water in a substance divided by the standard state partial vapor pressure of water. A “sufficiently low” water activity in this situation would be a water activity of the center material that does not compromise the structure or function of the protective, fat-based, crystalline barrier. The center material may comprise a combination of fat-based and water-based ingredients. A preferred center material comprises nut butter.

In exemplary embodiments, the center material is selected such that the center 20 maintains its shape during a coating and panning process, such as a process 200, which is described in further detail below. Preferably, the center material is selected to withstand pressure as centers 20 are stored in bulk and loaded in a system; to withstand increased temperatures as a binding layer 24 is applied during an enrobing process; and to withstand the tumbling and travel path of a panning process. In some embodiments, the center material is selected to have a sufficient firmness at room temperature to withstand handling and processing into a finished product. Alternatively, soft center materials could be coated to create a cover that can withstand handling.

In embodiments where the center material is to be co-extruded with the shell material, the center material is selected such that it has a viscosity that is compatible for co-extrusion with the outer shell formulation at the extrusion temperature. Preferably a center material will have a viscosity, at 23 degrees Celsius, sufficient to maintain the center material in a rigid shape, and a viscosity, at an extrusion temperature (for example 40 to 80 degrees Celsius), sufficient for the center material to be extruded into a cylindrical shape.

The Outer Shell

The outer layer comprises a binding layer 24 and exclusions. The binding layer 24 is made of a binder material. In some embodiments, a suitable binder material comprises a carbohydrate or water-based material, a compound material, or chocolate. In other embodiments, the binding material comprises carbohydrate-based ingredients including, but not limited to, corn syrup, sugar, inulin, tapioca syrup, sorghum syrup, brown rice syrup, honey, molasses and agave. In embodiments, the binding material may, optionally, include glycerol, gelling agents including pectin, alginate, gum acacia, carboxymethyl cellulose, xanthan gum, gellan gum or gelatin, and combinations thereof.

In some embodiments, the binder material is selected or formulated to be incompatible with the center material so that the binding material and the center material do not mix with each other. In preferred embodiments, the water activity of the binding material is selected or formulated to be sufficiently low such that water does not travel from the binding layer 24 to the exclusion layer 26. A suitable water activity for the binder is below 0.4, preferably below 0.35. In some embodiments, the binder formulation is transparent.

In preferred embodiments, the binding material is low in sugar. A suitable sugar content for the binding material is less than 30 percent by weight, preferably less than 25 percent, more preferably less than 20 percent. A low sugar binding material maintains the structural integrity of puffed or popped exclusions better than binding materials containing low sugar binder syrups from which popped exclusions readily absorb moisture due to the syrup's relatively high water activity.

Preferably, the binding material is not primarily fat based, has no artificial colors or preservatives, is non-genetically modified, is gluten free, is soy free, has no sugar alcohols, no high-fructose corn syrup, and requires no digestive warning labelling.

In some embodiments, a suitable binder material has a viscosity at 20 degrees Celsius of 280 to 420 Pascal-seconds at a shear rate of 1-s and 12 to 20 Pascal-seconds at a shear rate of 50-s, preferably 315 to 365 Pascal-seconds at a shear rate of 1-s and 14 to 18 Pascal-seconds at a shear rate of 50-s; more preferably 350 Pascal-seconds at a shear rate of 1-s and 16 Pascal-seconds at a shear rate of 50-s

Preferably, the binder provides sufficient tensile strength whereby an eight inch coextruded rope can hold its own weight for at least 30 seconds. Preferably, the binder; is transparent and has a crispy texture after baking. The binder water activity after baking is preferably less than 0.35.

Table 1 shows a preferred binding formulation that is suitable for use in a extrusion process with delicate exclusions.

TABLE 1

| Ingredient | % (w/w) |
|---|---|
| Reduced-sugar | 75.5 |
| Corn syrup | |
| Gylcerine/Glycerin | 13.1 |
| Gum | 1.5 |
| Water | 2.4 |
| Canola oil | 6.2 |
| Lecithin | 1.3 |
| TOTAL | 100 |

The gum was first hydrated in the water then added to the remaining syrup ingredients. Reduced-sugar corn syrup, as used herein, is corn syrup that comprises no greater than 25 percent by weight of sugar content of the solids where the corn syrup comprises has 80 percent by weight solids. The ingredients were mixed with low shear while being heated to 110 degrees Celsius until a uniform consistency was achieved. The binder was then cooled to room temperature.

The exclusion layer/outer shell 26 includes exclusions. Preferred exclusions include, but are not limited to nuts, oats, dried fruits, pretzels, and combinations thereof. In embodiments, exclusions include delicate exclusions, which are defined herein as exclusions that are damaged by threshold amounts of pressure or water during a manufacturing process, such as extrusion. Preferred delicate exclusions include whole food components such as puffed or popped rice, corn, quinoa, sorghum, amaranth, spelt, millet, kaniwa, groats, kamut, and the like. Such components are delicate in that they degrade or are destroyed when exposed to a sufficient water activity, and/or are placed under a certain amount of pressure. For most puffed or popped components, a maximum binder water activity of 0.40, preferably 0.35 is required to maintain the structural integrity and texture of the component during a manufacturing process. Binders with higher water activity will compromise the structure of the puffed or popped ingredients. In embodiments where the outer shell material is extruded to for a product, a range of sizes of exclusions (e.g., as measured by particle size distribution (PSD)) are preferably used to improve the flow of the material through a coextruder.

Referring again to FIG. 1, in preferred embodiments, the exclusions of the exclusion layer 26 cover the entire outer surface of the filled cluster product 10. In preferred embodiments, the exclusions have a small size, relative to the cluster as a whole, and are light weight in order to provide good coverage of the outside of the filled cluster product 10. In certain embodiments, the types of exclusions in the exclusion layer 26 are mixed.

Methods of Manufacturing the Filled Cluster Product

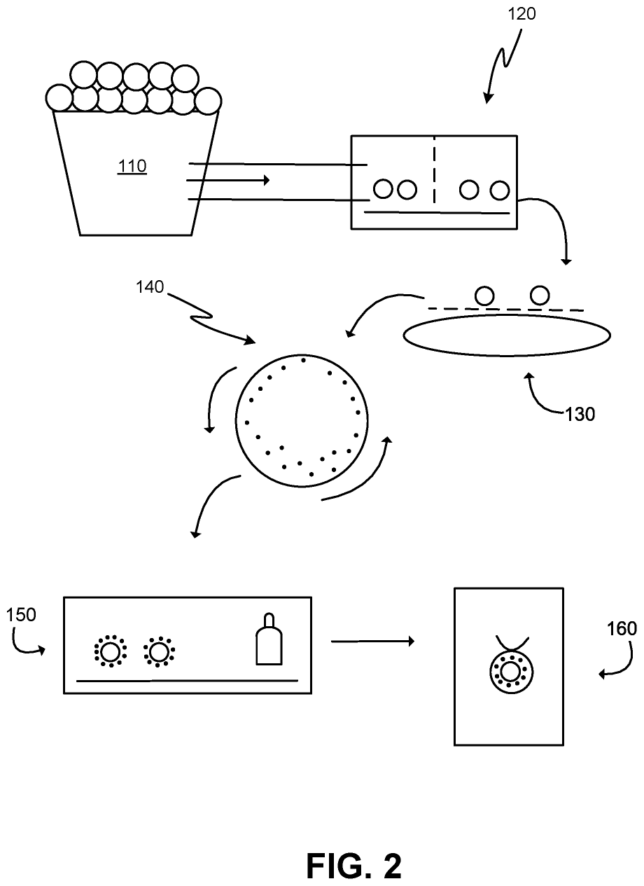

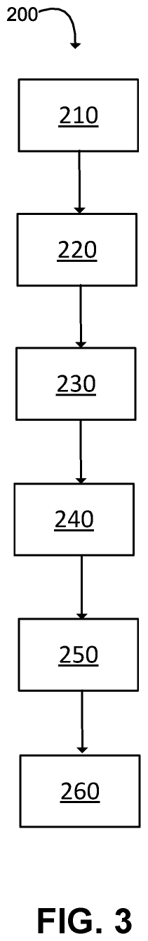

Referring to FIG. 2, an embodiment of a filled cluster manufacturing system is disclosed where the clusters are formed by enrobing the core particles with binder and then coating the enrobed cores with exclusions. The system 100 includes a hopper conveyor 110, an enrober 120, an enrobed center conveyor 130, a tumbling drum 140, a cooling tunnel 150, and a packaging machine 160. Referring to FIGS. 1-3, a process 200 of making the filled cluster product 10 with the system 100 is described. In this embodiment, the exclusions are not compressed during the process 200, avoiding damage to delicate exclusions.

According to a loading step 210, centers 20 are loaded in the hopper conveyor 110 and the hopper conveyor 110 moves the centers 20 to the enrober 120.

According to an enrobing step 220, at the enrober 120, the binding layer 24 is applied to the centers 20 at an elevated temperature, for example 39-44 degrees Celsius for preferred binding layer 24, to form enrobed centers 20/24.

The amount and temperature of the binding layer 24 coating is controlled. Too little coating leads to poor exclusion adhesion. Poor temperature control also leads to poor exclusion adhesion. Too much coating leads to non-uniform and misshapen pieces. Too much coating also leads to the coating seeping between exclusions after the exclusion layer 26 is applied.

Coating density varies with exclusion size, center size, and center density. For example, light centers may have a center to binding layer to exclusion ration of 20 to 40 and heavy centers may have a center to binding layer to exclusion make up of 40 to 35 to 25.

The enrobed centers 20/24 exit the enrober 120 and, according to a transfer step 230, are dropped onto the enrobed center conveyor 130. The enrobed center conveyor 130 has exclusions 26 on it. The exclusions 26 on the enrobed center conveyor 130 adhere to the binding layer 24 and begin to form the exclusion layer 26 of the outer shell 22.

According to a tumbling step 240, the enrobed center conveyor 130 carries the enrobed centers 20/24 to the tumbling drum 140. The tumbling drum 140 is flooded with exclusions 26 to further cover the enrobed centers 20/24 with exclusions 26 and complete the exclusion layer 26. At this point, the outer shell 22 is formed around the center 20 to complete the filled cluster product 10.

The filled cluster product 10 then exits the tumbling drum 140 and, according to a cooling step 250, moves through the cooling tunnel 150 to reduce the temperature of the filled cluster product 10. Upon exiting the cooling tunnel 150, the filled cluster product 10 is cooled and ready to be packaged.

According to a packaging step 260, the filled cluster product 10 is packaged by the packaging machine 160. The filled cluster product 10 may be packaged in various packaging including single-serve, pillow, stand up, writer, and book packaging.

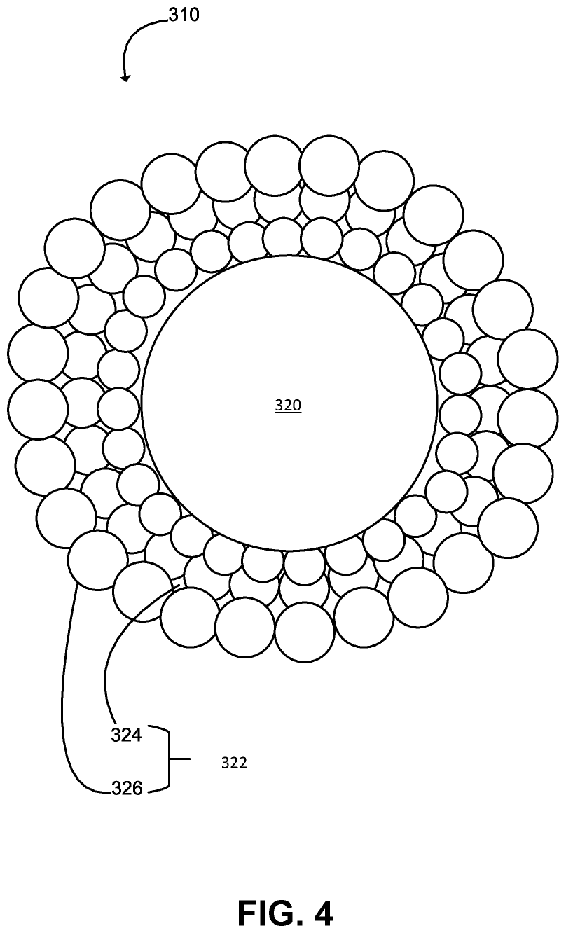

Referring to FIG. 4, a second exemplary embodiment is described. A filled cluster product 310 includes a center 320 and an outer shell 322. The outer shell 322 is a shell that includes exclusions 326 and binder 324. FIG. 4 is a cross-sectional view to show the center 320. An undissected view of the filled cluster product 310 shows the filled cluster product 310 as a sphere with only the outer shell 322 substantially exposed as the outer shell 322 encloses the center 320. In embodiments, the binding 324 is clear and only the exclusions 326 are visible.

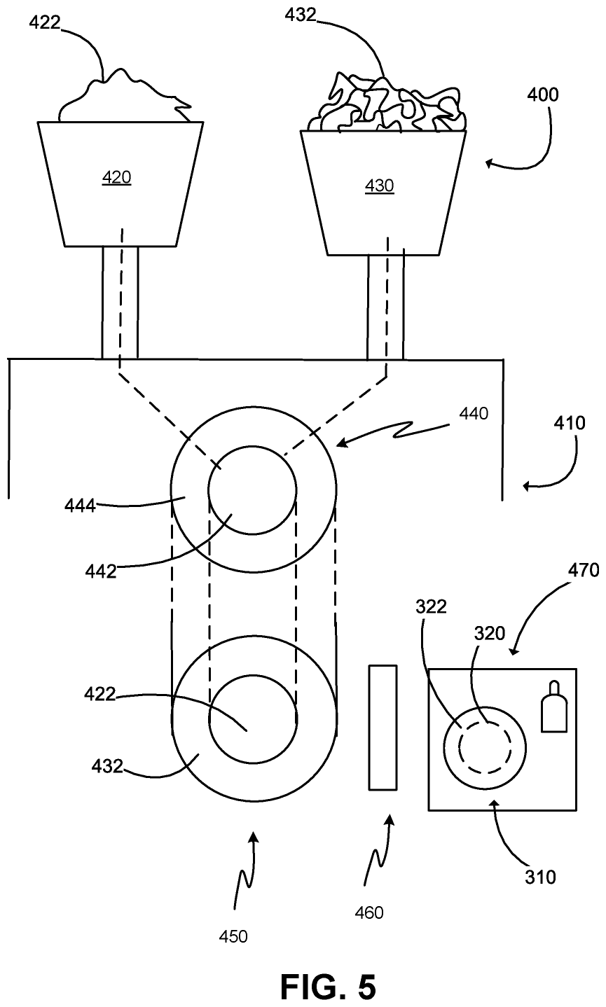

Referring to FIG. 5, an embodiment of a system for manufacturing filled cluster products by coextrusion is represented. The system 400 includes a coextruder 410. The to coextruder 410 comprises a first hopper 420 for loading a center material 422, a second hopper 430 for loading an outer shell material 432, and a die with an annulus 440 for coextruding the products. The annulus has a center 442 and an outer ring 444. When the center and outer materials are coextruded, the coextruder forms a rope 450, wherein the center material 422 forms the center of the rope and is covered by the outer shell material 432. The system 400 also includes a cutting and shaping device 460 (e.g., such as an iris cutter with an oscillating belt) and an oven 470.

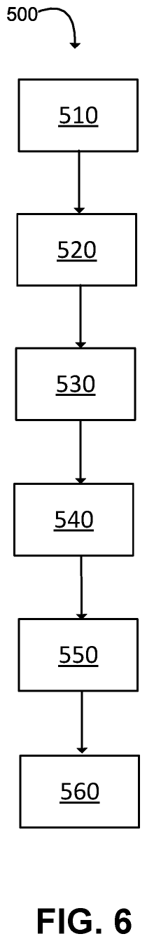

Referring to FIGS. 4-6, an embodiment of a process 500 of making the filled cluster product 310 with the system 400 is described.

In an embodiment using the binder formulation of Table 1, during pre-heating step 510, the first hopper 420, the second hopper 430, and the annulus 440 are heated to a temperature between 40 and 80 degrees Celsius, more preferably 50 to 70 degrees Celsius, most preferably 58 to 62 degrees Celsius degrees C. In general, higher temperatures improve the fluidity of materials and lower temperatures improve the set up time of the process. In some embodiments, including but not limited to those a using sugar-free binder, a substantially higher process temperature (greater than 120 degrees Celsius) is required.

During a first loading step 520, the first hopper 420 is loaded with center material 422. According to a heating step 530, the binding 324 is heated, to a temperature between 40 and 80 degrees Celsius, more preferably from 50 to 70 degrees Celsius, most preferably from 58 to 62 degrees Celsius. The heated binding 324 is combined with exclusions 326 according to a selected ratio to provide the outer shell material 432. The second hopper 430 is loaded with the outer shell material 432.

During a coextrusion step 540, the coextruder 410 extrudes the center material 422 and the outer shell material 432 through the die and out the annulus 440 to form the filled cluster product 310. In an embodiment, the coextruder 410 moves the center material 422 and outer shell material 432 from the hoppers 420, 430 through the die where each is compressed and shaped before moving through the center 442 and the outer ring 444 of the annulus 440. The die and annulus 440 shape the outer shell material 432 into a hollow cylinder and shape the center material 422 into a cylinder that fills the hollow cylinder of the outer shell material 432. The rope 450 of outer shell material 432 with a center material 422 center continuously flows from the annulus 440.

During a cutting and shaping step 550, the rope 450 is cut and shaped by the cutting and shaping device 460. For example, a piece of the rope 450 is cut and shaped into a sphere such that the outer shell material 432 covers the exposed center material 422 at the ends of the rope piece. After cutting and shaping, the center 320 and outer shell 322 of the filled cluster product 310 are formed.

During a baking step 560, the filled cluster product 310 is baked in an oven, to preferably at a temperature ranging from 107 to 121 degrees Celsius, for up to 45 minutes. The endpoint of the baking step is reached when the binder material develops a sufficiently crispy texture. One of skill in the art will recognize that the baking time and temperature may be varied to reach the desired endpoint. As used herein, a sufficiently crispy texture corresponds to a binder material comprising a water activity of less than 0.3, preferably less than 0.25, more preferably less than 1.5.

System and material adjustments to get the materials to flow through the coextruder 410 include a ratio of binding 324 to exclusion 326, the temperature applied to the materials by the coextruder 410, the exclusion 326 composition, and the size of the annulus 440. With respect to the exclusion 326 composition, a small percentage of nuts can improve the flow of the outer shell material 432 because compression of the nuts leads to expression of oil that improves the “slip” of the binding 324. Here, the delicate exclusions 326 in the outer shell material 432 absorb excess oil.

The size of the annulus 440 determines the size of the center 320 (e.g., an inner diameter) and the thickness of the outer shell 322 (e.g., difference between an outer diameter of the center 442 and an outer diameter of the outer ring 444). A larger size of the filled cluster product 310 generally results in a greater degree of structural integrity of the exclusions 326 because the pressures applied by the coextruder 410 are lower. The coextruder 410 applies greater pressures to the outer shell material 432 and the center materials 422 to make smaller filled cluster products 310.

Delicate exclusions 326 are easily damaged by the pressure or forces of the coextruder 410. Previously, in order to circumvent this problem, a high level of binding 324 was typically used to facilitate flow of a stream of the outer shell material 432 through the die and annulus 440 of the coextruder 410. Previously, the binding 324 fraction of the outer shell 322 was expected to be 60-70% of the stream of outer shell material 432 to enable the stream of outer shell material 432 to flow through the die and annulus 440. Previously, another way to circumvent he problem was to wet the exclusions be wetted to make them cohesive and flexible enough to pass though the die and annulus 440 with reduced damage. However, the increased moisture used in this production path destroys the structural integrity and texture of the delicate puffed or popped exclusions 326.

In embodiments where the amount of delicate exclusions 326 in the outer shell 322 is significant, a coextrusion process becomes difficult if the amount of binding 324 and the water activity of the binding 324 are limited to increase the relative amount of delicate exclusions 326 in the outer shell 322 and to prevent damage to the delicate exclusions 326.

However, using the binding formulation of Table 1, an outer shell mixture with a binding to delicate exclusion weight ratio as low as 50 to 50 may be successfully coextruded while maintaining the structural integrity of delicate extrusions. The resulting filled cluster to product 310 has an outer shell 322 including a high degree of puffed or popped exclusions 326 with low binding 324 to exclusions 326 ratio and maintains the structural integrity of the exclusions 326.

The foregoing has broadly outlined some of the aspects and features of the various embodiments, which should be construed to be merely illustrative of various potential applications of the disclosure. Other beneficial results can be obtained by applying the disclosed information in a different manner or by combining various aspects of the disclosed embodiments. Accordingly, other aspects and a more comprehensive understanding may be obtained by referring to the detailed description of the exemplary embodiments taken in conjunction with the accompanying drawings, in addition to the scope defined by the claims.

The above-described embodiments are merely exemplary illustrations of implementations that are set forth for a clear understanding of principles. Variations, modifications, and combinations may be made to the above-described embodiments may be made without departing from the scope of the claims. All such variations, modifications, and combinations are included herein by the scope of this disclosure and the following claims.

1. A method for producing a filled cluster product comprising:
(a) providing a center material having a first viscosity at 23 degrees Celsius that is sufficient to maintain the center material in a rigid shape, and a second viscosity at a temperature in the range of from 40 to 80 degrees Celsius that is sufficiently low for the center material to be extruded;
(b) providing an outer shell material comprising:
a binder comprising a binder water activity of no more than 0.35, and
a plurality of delicate exclusions,
wherein the plurality of delicate extrusions comprises greater than 40 percent by weight of the outer shell material;
(c) heating the center material and the outer shell material to a temperature of from 40 to 80 degrees Celsius in an extrusion apparatus;
(d) co-extruding the center material and the outer shell material through a die and annulus such that the die and annulus form the outer shell material into a hollow shape and form the center material into a sold shape that fills the hollow shape of the outer shell material to produce a rope,
(e) cutting the rope laterally into a plurality of pieces, each of the plurality of pieces comprising first and second cut ends, the first and second cut ends each comprising an exposed center material surface;
(f) baking each of the plurality of pieces at a temperature between 107 and 121 degrees Celsius, for a time sufficient to produce a crisp binder texture, to yield a filled cluster product.

2. The method of claim 1, further comprising, after step (e), shaping each of the plurality of pieces into a sphere, such that the outer shell material covers the exposed center material at the first and second cut ends of each of the plurality of pieces.

3. The method of claim 1, wherein step (a) further comprises providing a center material comprising a fat-based material selected from the group consisting of: nut butter, seed butter, compound, chocolate, and combinations thereof.

4. The method of claim 1, wherein step (a) further comprises providing a center material comprising a water-based material selected from the group consisting of: caramel, high protein caramel, nougat, pectin gel, starch gel, and combinations thereof.

5. The method of claim 1, wherein step (b) further comprises a plurality of delicate exclusions selected from the group consisting of puffed rice, puffed corn, puffed quinoa, puffed sorghum, puffed amaranth, puffed spelt, puffed millet, puffed kaniwa, puffed groats, puffed kamut, and combinations thereof.

6. The method of claim 1, wherein the binder is selected from the group consisting of: a carbohydrate; a water-based material; a compound material or chocolate.

7. The method of claim 1, wherein the binder comprises an ingredient selected from the group consisting of: corn syrup; sugar; inulin; tapioca syrup; sorghum syrup; brown rice syrup; honey; molasses; agave; glycerol; gelling agents; pectin; alginate; gum acacia; carboxymethyl cellulose xanthan gum; gellan gum, and gelatin.

8. The method of claim 1, wherein the binder comprises reduced sugar corn syrup in an amount ranging from 65 to 85 percent by weight of the binder.

9. The method of claim 1, wherein the binder comprises glycerin in an amount ranging from 11 to 15 percent by weight of the binder.

10. The method of claim 1, wherein the binder comprises water in an amount ranging from 1 to 5 percent by weight of the binder.

11. The method of claim 1, wherein the binder comprises vegetable oil in an amount ranging from 5 to 7 percent by weight of the binder.

12. The method of claim 1, wherein the binder comprises lecithin in an amount ranging from 0.5 to 2 percent by weight of the binder.

13. The method of claim 1, wherein step (b) comprises providing the outer shell material comprising the binder and the delicate exclusions, wherein the delicate extrusions comprise greater than 40 percent by weight of the outer shell material, and wherein the binder material comprises a viscosity at 20 degrees Celsius of 280 to 420 Pascal-seconds at a shear rate of 1-s and 12 to 20 Pascal-seconds at a shear rate of 50-s.

14. The method of claim 1, wherein step (c) comprises heating the center material and the outer shell material to a temperature of from 50 to 70 degrees Celsius in an extrusion apparatus.

15. The method of claim 1, wherein step (c) comprises heating the center material and the outer shell material to a temperature of from 58 to 62 degrees Celsius in an extrusion apparatus.

16. The method of claim 1, wherein the binder comprises less than 3 percent by weight of water.

17. The method of claim 1, wherein the binder comprises: 75.5 percent by weight of corn syrup; 13.1 percent by weight of glycerin; 1.5 percent by weight of gum; 2.4 percent by weight of water; 6.2 percent by weight of canola oil and 1.3 percent by weight of lecithin.

18. The method of claim 1, wherein the binder has a viscosity at 20 degrees Celsius of 280 to 420 Pascal-seconds at a shear rate of 1-s and 12 to 20 Pascal-seconds at a shear rate of 50-s.
